(19) United States
(12) Patent Application Publication
(10) Pub. No.: US 2011/0038419 A1
(43) Pub. Date: Feb. 17, 2011

(54) METHOD AND APPARATUS FOR ENCODING/DECODING IMAGE BY CONTROLLING ACCURACY OF MOTION VECTOR

(75) Inventors: Woo-jin HAN, Suwon-si (KR); Sang-rae LEE, Suwon-si (KR); Jong-bum CHOI, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/856,029

(22) Filed: Aug. 13, 2010

(30) Foreign Application Priority Data
Aug. 13, 2009 (KR) 10-2009-0074897

(51) Int. Cl. H04N 7/26

(52) U.S. Cl. 375/240.16; 375/E07.104

(57) ABSTRACT

Disclosed are a method and apparatus for encoding an image whereby a current coding unit is predicted by variably controlling accuracy of a motion vector and motion compensation is performed according to the result of prediction, and a method and apparatus for decoding an image encoded by the method and apparatus for encoding an image.

### CROSS-REFERENCE TO RELATED PATENT APPLICATION

This application claims the benefit of Korean Patent Application No. 10-2009-0074897, filed on Aug. 13, 2009, in the Korean Intellectual Property Office, the disclosure of which is incorporated herein in its entirety by reference.

### BACKGROUND

1. Field

The exemplary embodiments relate to a method and apparatus for encoding/decoding an image, and more particularly, to a method and apparatus for encoding/decoding an image by using inter prediction.

2. Description of the Related Art

A codec, such as Moving Pictures Experts Group (MPEG)-4 H.264/MPEG-4 Advanced Video Coding (AVC), prediction-encodes an image by using intra prediction or inter prediction. For inter prediction, an apparatus for encoding an image searches the same block as a current block or a similar block to the current block from a reference picture, performs motion compensation of the current block on the result of searching, and encodes an image. As the motion vector is more accurately estimated, prediction is more accurately performed. Thus, the compression ratio upon encoding is increased.

### SUMMARY

The exemplary embodiments provide a method and apparatus for encoding/decoding an image by using inter prediction.

The exemplary embodiment also provides a computer readable recording medium having recorded thereon a program for executing the method of encoding/decoding an image by using inter prediction.

According to an aspect of the an exemplary embodiment, there is provided a method of encoding an image, the method comprising: determining accuracy of a motion vector used to predict a current coding unit based on a depth that indicates a degree stepwise decreasing from the size of a maximum coding unit to the size of a predetermined coding unit; estimating a motion vector of the current coding unit according to the determined accuracy of the motion vector; performing motion compensation on the current coding unit by using the estimated motion vector; and encoding the current coding unit based on the result of motion compensation.

According to an aspect of an exemplary embodiment, there is provided an apparatus for encoding an image, the apparatus comprising: an accuracy determiner determining accuracy of a motion vector used to predict a current coding unit based on a depth that indicates a degree stepwise decreasing from the size of a maximum coding unit to the size of a predetermined coding unit; a motion vector estimator estimating a motion vector of the current coding unit according to the determined accuracy of the motion vector; a motion compensator performing motion compensation on the current coding unit by using the estimated motion vector; and an encoder encoding the current coding unit based on the result of motion compensation.

According to an aspect of an exemplary embodiment, there is provided a method of decoding an image, the method comprising: decoding data about a current coding unit and data about a motion vector estimated with predetermined accuracy; performing motion compensation on the current coding unit by using the decoded motion vector; and restoring the current coding unit based on the result of decoding the data about the current coding unit and the result of motion compensation, wherein the accuracy is accuracy of the motion vector determined based on a depth that indicates a degree stepwise decreasing from the size of a maximum coding unit to the size of a predetermined coding unit.

According to an aspect an exemplary embodiment, there is provided an apparatus for decoding an image, the apparatus comprising: a decoder decoding data about a current coding unit and data about a motion vector estimated with predetermined accuracy; a motion compensator performing motion compensation on the current coding unit by using the decoded motion vector; and a restoration unit restoring the current coding unit based on the result of decoding the data about the current coding unit and the result of motion compensation, wherein the accuracy is accuracy of the motion vector determined based on a depth that indicates a degree stepwise decreasing from the size of a maximum coding unit to the size of a predetermined coding unit.

According to another aspect of an exemplary embodiment, there is provided a computer readable recording medium storing computer readable program for executing the method of encoding a image and the method of decoding a image.

### BRIEF DESCRIPTION OF THE DRAWINGS

The above and other features and advantages of the exemplary embodiment will become more apparent by describing in detail exemplary embodiments thereof with reference to the attached drawings in which:

FIG. 1 is a block diagram of an apparatus for encoding an image according to an exemplary embodiment;

FIG. 2 is a block diagram of an apparatus for decoding an image according to an exemplary embodiment;

FIG. 3 illustrates hierarchical coding units according to an exemplary embodiment;

FIG. 4 is a block diagram of an image encoder based on a coding unit, according to an exemplary embodiment;

FIG. 5 is a block diagram of an image decoder based on a coding unit, according to an exemplary embodiment;

FIG. 6 illustrates a maximum coding unit, a sub coding unit, and a prediction unit, according to an exemplary embodiment;

FIG. 7 illustrates a coding unit and a transformation unit, according to an exemplary embodiment;

FIGS. 8A and 8B illustrate division shapes of a coding unit, a prediction unit, and a frequency transformation unit, according to an exemplary embodiment;

FIG. 9 is a block diagram of an apparatus for encoding an image according to another exemplary embodiment;

FIGS. 10A and 10B illustrate interpolated reference pictures according to an exemplary embodiment;

FIG. 11 is a block diagram of an apparatus for decoding an image according to another exemplary embodiment;

FIG. 12 is a flowchart illustrating a method of encoding an image according to an exemplary embodiment; and

FIG. 13 is a flowchart illustrating a method of decoding an image according to an exemplary embodiment.

### DETAILED DESCRIPTION

The exemplary embodiments will now be described more fully with reference to the accompanying drawings, in which exemplary embodiments are shown. In the exemplary embodiments, “unit” may or may not refer to a unit of size, depending on its context. In the present specification, an “image” may denote a still image for a video or a moving image, that is, the video itself.

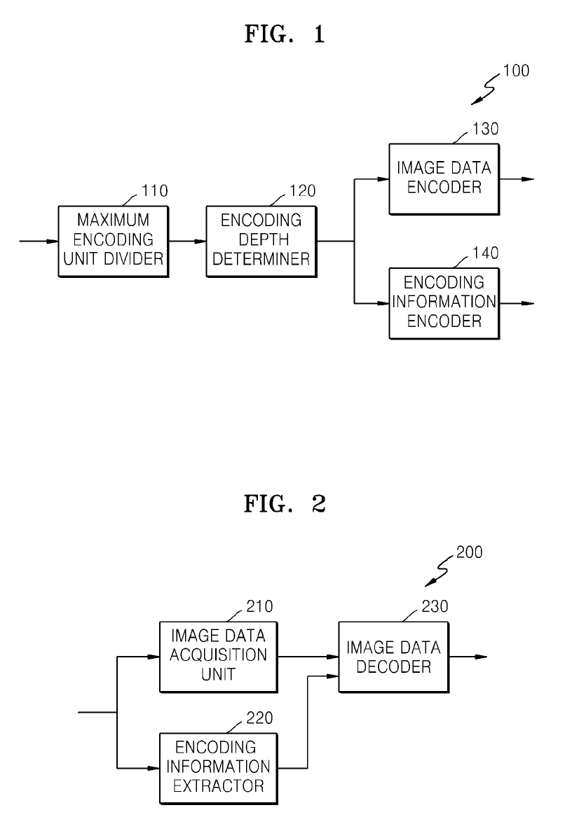

FIG. 1 is a block diagram of an apparatus 100 for encoding an image, according to an exemplary embodiment.

Referring to FIG. 1, the apparatus 100 includes a maximum coding unit divider 110, an encoding depth determiner 120, an image data encoder 130, and an encoding information encoder 140.

The maximum coding unit divider 110 can divide a current picture or slice based on a maximum coding unit that is a coding unit of the largest size. That is, the maximum coding unit divider 110 can divide the current picture or slice to obtain at least one maximum coding unit.

According to an exemplary embodiment, a coding unit can be represented using a maximum coding unit and a depth. As described above, the maximum coding unit indicates a coding unit having the largest size from among coding units of the current picture, and the depth indicates the size of a sub coding unit obtained by hierarchically decreasing the coding unit. As a depth increases, a coding unit can decrease in size from a maximum coding unit to a minimum coding unit, wherein a depth of the maximum coding unit is defined as a minimum depth and a depth of the minimum coding unit is defined as a maximum depth. Since the size of a coding unit decreases from a maximum coding unit as a depth increases, a sub coding unit of a k^{th} depth can include a plurality of sub coding units of a (k+n)^{th} depth (k and n are integers equal to or greater than 1).

According to an increase of the size of a picture to be encoded, encoding an image in a greater coding unit can result in a higher image compression ratio. However, if a greater coding unit is fixed, an image cannot be efficiently encoded by taking into account the continuously changing image characteristics.

For example, when a smooth area such as the sea or sky is encoded, the greater a coding unit is, the compression ration can increase. However, when a complex area such as people or buildings is encoded, the smaller a coding unit is, the more a compression ratio can increase.

Accordingly, according to an exemplary embodiment, a different maximum image coding unit and a different maximum depth are set for each picture or slice. Since a maximum depth denotes the maximum number of times by which a coding unit can decrease, the size of each minimum coding unit included in a maximum image coding unit can be variably set according to a maximum depth.

The encoding depth determiner 120 determines a maximum depth. The maximum depth can be determined based on calculation of Rate-Distortion (R-D) cost. The maximum depth may be determined differently for each picture or slice or for each maximum coding unit. The determined maximum depth is provided to the encoding information encoder 140, and image data according to maximum coding units is provided to the image data encoder 130.

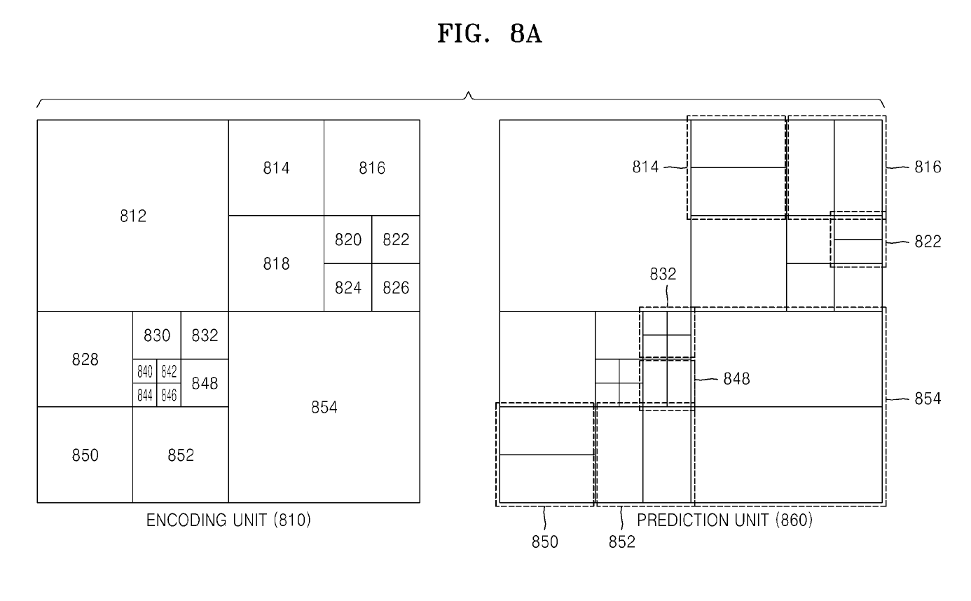

The maximum depth denotes a coding unit having the smallest size, which can be included in a maximum coding unit, i.e., a minimum coding unit. In other words, a maximum coding unit can be divided into sub coding units having different sizes according to different depths. This is described in detail later with reference to FIGS. 8A and 8B. In addition, the sub coding units having different sizes, which are included in the maximum coding unit, can be predicted or transformed based on processing units having different sizes. In other words, the apparatus 100 can perform a plurality of processing operations for image encoding based on processing units having various sizes and various shapes. To encode image data, processing operations such as prediction, transformation, and entropy encoding are performed, wherein processing units having the same size may be used for every operation or processing units having different sizes may be used for every operation.

For example, the apparatus 100 can select a processing unit that is different from a coding unit to predict the coding unit.

When the size of a coding unit is 2N×2N (where N is a positive integer), processing units for prediction may be 2N×2N, 2N×N, N×2N, and N×N. In other words, motion prediction may be performed based on a processing unit having a shape whereby at least one of height and width of a coding unit is equally divided by two. Hereinafter, a processing unit, which is the base of prediction, is defined as a ‘prediction unit’.

A prediction mode may be at least one of an intra mode, an inter mode, and a skip mode, and a specific prediction mode can be performed for only a prediction unit having a specific size or shape. For example, the intra mode can be performed for only prediction units having the sizes of 2N×2N and N×N of which the shape is a square. Further, the skip mode can be performed for only a prediction unit having the size of 2N×2N. If a plurality of prediction units exist in a coding unit, the prediction mode with the least encoding errors can be selected after performing prediction for every prediction unit.

Alternatively, the apparatus 100 can perform frequency transformation on image data based on a processing unit having a different size from a coding unit. For the frequency transformation in the coding unit, the frequency transformation can be performed based on a processing unit having a size equal to or smaller than that of the coding unit. Hereinafter, a processing unit, which is the base of frequency transformation, is defined as a ‘transformation unit’. The frequency transformation may be a Discrete Cosine Transform (DCT) or a Karhunen Loeve Transform (KLT).

The encoding depth determiner 120 can determine sub coding units included in a maximum coding unit using RD optimization based on a Lagrangian multiplier. In other words, the encoding depth determiner 120 can determine the shapes a plurality of sub coding units divided from the maximum coding unit, wherein the plurality of sub coding units have different sizes according to their depths. The image data encoder 130 outputs a bitstream by encoding the maximum coding unit based on the division shapes, i.e., the shapes which divide the maximum coding unit, as determined by the encoding depth determiner 120.

The encoding information encoder 140 encodes information about an encoding mode of the maximum coding unit determined by the encoding depth determiner 120. In other words, the encoding information encoder 140 outputs a bitstream by encoding information about a division shape of the maximum coding unit, information about the maximum depth, and information about an encoding mode of a sub coding unit for each depth. The information about the encoding mode of the sub coding unit can include information about a prediction unit of the sub coding unit, information about a prediction mode for each prediction unit, and information about a transformation unit of the sub coding unit.

Since sub coding units having different sizes exist for each maximum coding unit and information about an encoding mode must be determined for each sub coding unit, information about at least one encoding mode can be determined for one maximum coding unit.

The apparatus 100 can generate sub coding units by equally dividing both height and width of a maximum coding unit by two according to an increase of depth. That is, when the size of a coding unit of a k^{th} depth is 2N×2N, the size of a coding unit of a (k+1)^{th} depth is N×N.

Accordingly, the apparatus 100 according to an exemplary embodiment can determine an optimal division shape for each maximum coding unit based on sizes of maximum coding units and a maximum depth in consideration of image characteristics. By variably adjusting the size of a maximum coding unit in consideration of image characteristics and encoding an image through division of a maximum coding unit into sub coding units of different depths, images having various resolutions can be more efficiently encoded.

FIG. 2 is a block diagram of an apparatus 200 for decoding an image according to an exemplary embodiment.

Referring to FIG. 2, the apparatus 200 includes an image data acquisition unit 210, an encoding information extractor 220, and an image data decoder 230.

The image data acquisition unit 210 acquires image data according to maximum coding units by parsing a bitstream received by the apparatus 200 and outputs the image data to the image data decoder 230. The image data acquisition unit 210 can extract information about a maximum coding unit of a current picture or slice from a header of the current picture or slice. In other words, the image data acquisition unit 210 divides the bitstream in the maximum coding unit so that the image data decoder 230 can decode the image data according to maximum coding units.

The encoding information extractor 220 extracts information about a maximum coding unit, a maximum depth, a division shape of the maximum coding unit, an encoding mode of sub coding units from the header of the current picture by parsing the bitstream received by the apparatus 200. The information about a division shape and the information about an encoding mode are provided to the image data decoder 230.

The information about a division shape of the maximum coding unit can include information about sub coding units having different sizes according to depths included in the maximum coding unit, and the information about an encoding mode can include information about a prediction unit according to sub coding unit, information about a prediction mode, and information about a transformation units.

The image data decoder 230 restores the current picture by decoding image data of every maximum coding unit based on the information extracted by the encoding information extractor 220. The image data decoder 230 can decode sub coding units included in a maximum coding unit based on the information about a division shape of the maximum coding unit. A decoding process can include a prediction process including intra prediction and motion compensation and an inverse transformation process.

The image data decoder 230 can perform intra prediction or inter prediction based on information about a prediction unit and information about a prediction mode in order to predict a prediction unit. The image data decoder 230 can also perform inverse transformation for each sub coding unit based on information about a transformation unit of a sub coding unit.

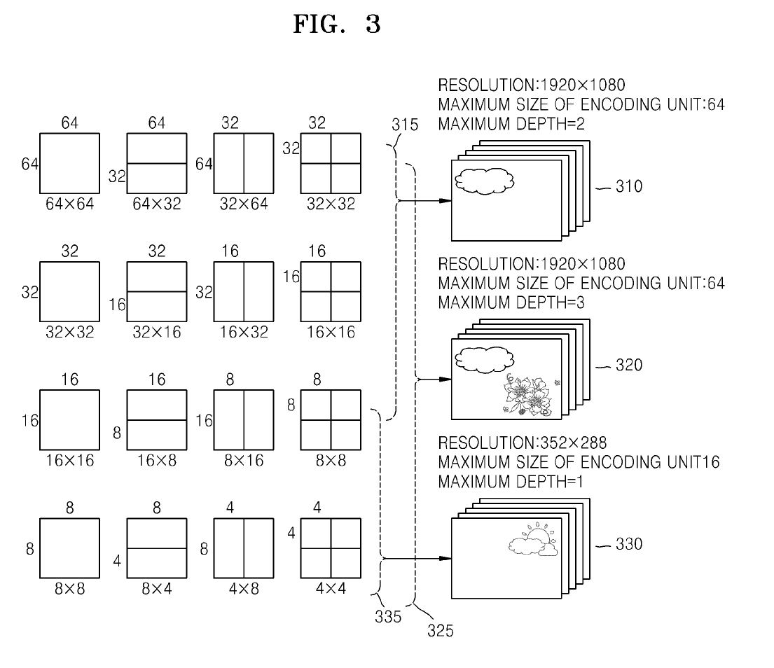

FIG. 3 illustrates hierarchical coding units according to an exemplary embodiment.

Referring to FIG. 3, the hierarchical coding units according to an exemplary embodiment can include coding units whose width×heights are 64×64, 32×32, 16×16, 8×8, and 4×4. Besides these coding units having perfect square shapes, coding units whose width×heights are 64×32, 32×64, 32×16, 16×32, 16×8, 8×16, 8×4, and 4×8 may also exist.

Referring to FIG. 3, for image data 310 whose resolution is 1920×1080, the size of a maximum coding unit is set to 64×64, and a maximum depth is set to 2.

For image data 320 whose resolution is 1920×1080, the size of a maximum coding unit is set to 64×64, and a maximum depth is set to 3. For image data 330 whose resolution is 352×288, the size of a maximum coding unit is set to 16×16, and a maximum depth is set to 1.

When the resolution is high or the amount of data is great, it is preferable, but not necessary, that a maximum size of a coding unit is relatively great to increase a compression ratio and exactly reflect image characteristics. Accordingly, for the image data 310 and 320 having higher resolution than the image data 330, 64×64 can be selected as the size of a maximum coding unit.

A maximum depth indicates the total number of layers in the hierarchical coding units. Since the maximum depth of the image data 310 is 2, a coding unit 315 of the image data 310 can include a maximum coding unit whose longer axis size is 64 and sub coding units whose longer axis sizes are 32 and 16, according to an increase of a depth.

On the other hand, since the maximum depth of the image data 330 is 1, a coding unit 335 of the image data 330 can include a maximum coding unit whose longer axis size is 16 and coding units whose longer axis sizes is 8, according to an increase of a depth.

However, since the maximum depth of the image data 320 is 4, a coding unit 325 of the image data 320 can include a maximum coding unit whose longer axis size is 64 and sub coding units whose longer axis sizes are 32, 16, 8 and 4 according to an increase of a depth. Since an image is encoded based on a smaller sub coding unit as a depth increases, the exemplary embodiment is suitable for encoding an image including more minute details in scenes.

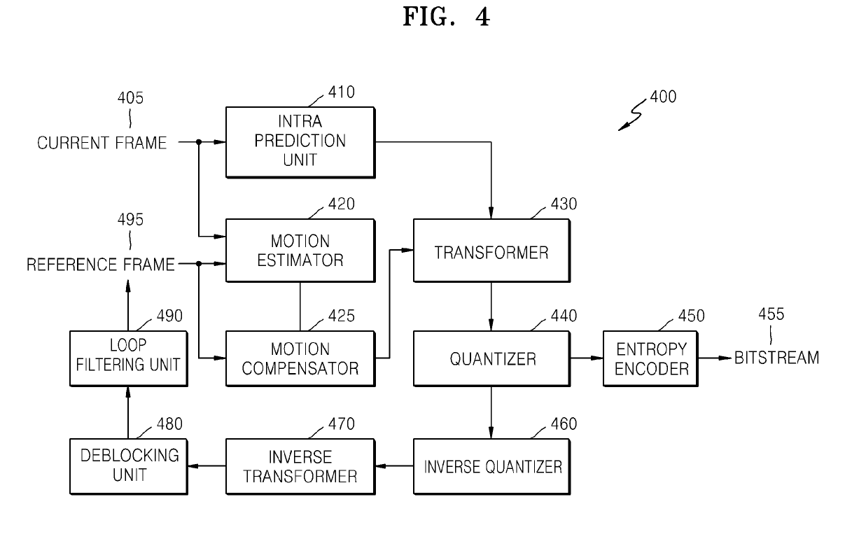

FIG. 4 is a block diagram of an image encoder 400 based on a coding unit, according to an exemplary embodiment.

An intra prediction unit 410 performs intra prediction on prediction units of the intra mode in a current frame 405, and a motion estimator 420 and a motion compensator 425 perform inter prediction and motion compensation on prediction units of the inter mode using the current frame 405 and a reference frame 495.

Residual values are generated based on the prediction units output from the intra prediction unit 410, the motion estimator 420, and the motion compensator 425, and the generated residual values are output as quantized transform coefficients by passing through a transformer 430 and a quantizer 440.

The quantized transform coefficients are restored to residual values by passing through an inverse quantizer 460 and a frequency inverse transformer 470, and the restored residual values are post-processed by passing through a deblocking unit 480 and a loop filtering unit 490 and output as the reference frame 495. The quantized transform coefficients can be output as a bitstream 455 by passing through an entropy encoder 450.

To perform encoding based on an encoding method according to an exemplary embodiment, components of the image encoder 400, i.e., the intra prediction unit 410, the motion estimator 420, the motion compensator 425, the transformer 430, the quantizer 440, the entropy encoder 450, the inverse quantizer 460, the frequency inverse transformer 470, the deblocking unit 480 and the loop filtering unit 490, perform image encoding processes based on a maximum coding unit, a sub coding unit according to depths, a prediction unit, and a transformation unit.

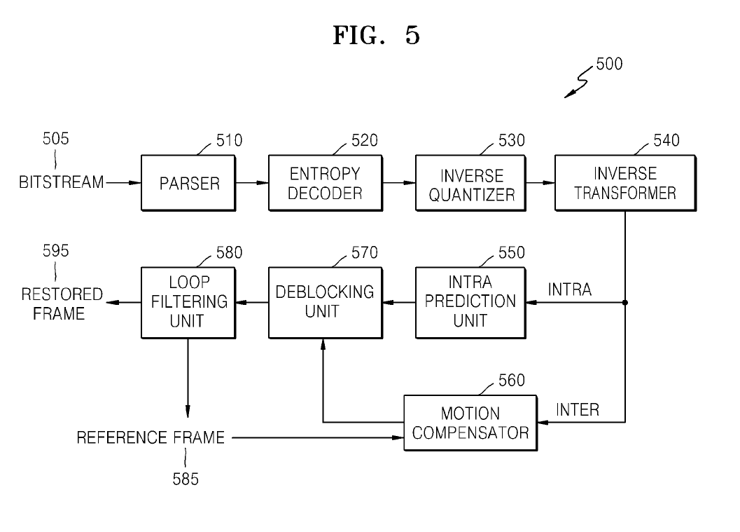

FIG. 5 is a block diagram of an image decoder 500 based on a coding unit, according to an exemplary embodiment.

A bitstream 505 passes through a parser 510 so that encoded image data to be decoded and encoding information necessary for decoding are parsed. The encoded image data is output as inverse-quantized data by passing through an entropy decoder 520 and an inverse quantizer 530 and restored to residual values by passing through an inverse transformer 540. The residual values are restored according to coding units by being added to an intra prediction result of an intra prediction unit 550 or a motion compensation result of a motion compensator 560. The restored coding units are used for prediction of next coding units or a next picture by passing through a deblocking unit 570 and a loop filtering unit 580.

To perform decoding based on a decoding method according to an exemplary embodiment, components of the image decoder 500, i.e., the parser 510, the entropy decoder 520, the inverse quantizer 530, the inverse transformer 540, the intra prediction unit 550, the motion compensator 560, the deblocking unit 570 and the loop filtering unit 580, perform image decoding processes based on a maximum coding unit, a sub coding unit according to depths, a prediction unit, and a transformation unit.

In particular, the intra prediction unit 550 and the motion compensator 560 determine a prediction unit and a prediction mode in a sub coding unit by considering a maximum coding unit and a depth, and the inverse transformer 540 performs frequency inverse transformation by considering the size of a transformation unit.

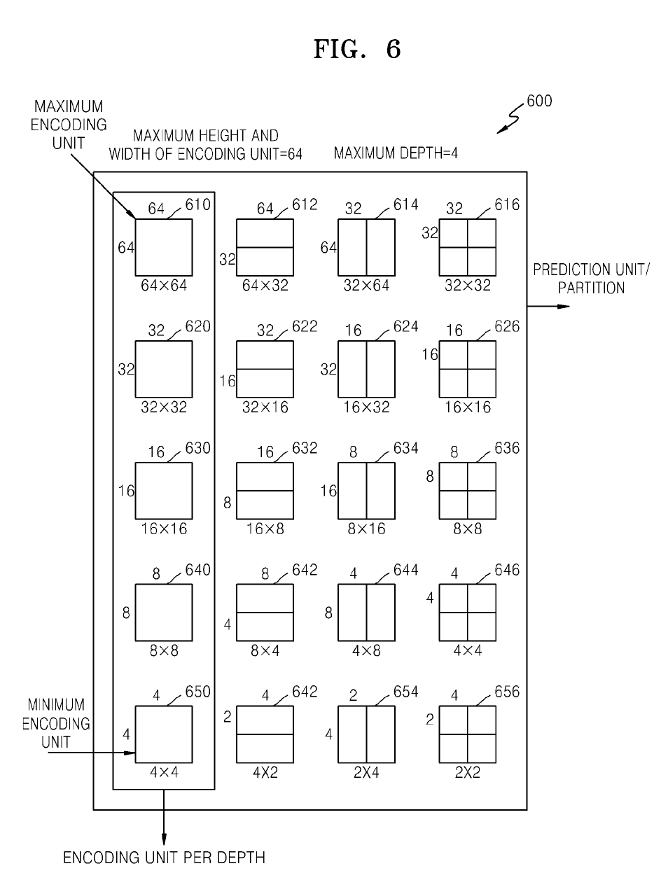

FIG. 6 illustrates a maximum coding unit, a sub coding unit, and a prediction unit, according to an exemplary embodiment.

The apparatus 100 and the apparatus 200 according to an exemplary embodiment use hierarchical coding units to perform encoding and decoding in consideration of image characteristics. A maximum coding unit and a maximum depth can be adaptively set according to the image characteristics or variously set according to requirements of a user.

A hierarchical coding unit structure 600 according to an exemplary embodiment illustrates a maximum coding unit 610 whose height and width are 64 and maximum depth is 4. A depth increases along a vertical axis of the hierarchical coding unit structure 600, and as a depth increases, heights and widths of sub coding units 620 to 650 decrease. Prediction units of the maximum coding unit 610 and the sub coding units 620 to 650 are shown along a horizontal axis of the hierarchical coding unit structure 600.

The maximum coding unit 610 has a depth of 0 and the size of a coding unit, i.e., height and width, of 64×64. A depth increases along the vertical axis, and there exist a sub coding unit 620 whose size is 32×32 and depth is 1, a sub coding unit 630 whose size is 16×16 and depth is 2, a sub coding unit 640 whose size is 8×8 and depth is 3, and a sub coding unit 650 whose size is 4×4 and depth is 4. The sub coding unit 650 whose size is 4×4 and depth is 4 is a minimum coding unit, and the minimum coding unit may be divided into prediction units, each of which is less than the minimum coding unit.

Referring to FIG. 6, examples of a prediction unit are shown along the horizontal axis according to each depth. That is, a prediction unit of the maximum coding unit 610 whose depth is 0 may be a prediction unit whose size is equal to the coding unit 610, i.e., 64×64, or a prediction unit 612 whose size is 64×32, a prediction unit 614 whose size is 32×64, or a prediction unit 616 whose size is 32×32, which has a size smaller than the coding unit 610 whose size is 64×64.

A prediction unit of the coding unit 620 whose depth is 1 and size is 32×32 may be a prediction unit whose size is equal to the coding unit 620, i.e., 32×32, or a prediction unit 622 whose size is 32×16, a prediction unit 624 whose size is 16×32, or a prediction unit 626 whose size is 16×16, which has a size smaller than the coding unit 620 whose size is 32×32.

A prediction unit of the coding unit 630 whose depth is 2 and size is 16×16 may be a prediction unit whose size is equal to the coding unit 630, i.e., 16×16, or a prediction unit 632 whose size is 16×8, a prediction unit 634 whose size is 8×16, or a prediction unit 636 whose size is 8×8, which has a size smaller than the coding unit 630 whose size is 16×16.

A prediction unit of the coding unit 640 whose depth is 3 and size is 8×8 may be a prediction unit whose size is equal to the coding unit 640, i.e., 8×8, or a prediction unit 642 whose size is 8×4, a prediction unit 644 whose size is 4×8, or a prediction unit 646 whose size is 4×4, which has a size smaller than the coding unit 640 whose size is 8×8.

Finally, the coding unit 650 whose depth is 4 and size is 4×4 is a minimum coding unit and a coding unit of a maximum depth, and a prediction unit of the coding unit 650 may be a prediction unit 650 whose size is 4×4, a prediction unit 652 having a size of 4×2, a prediction unit 654 having a size of 2×4, or a prediction unit 656 having a size of 2×2.

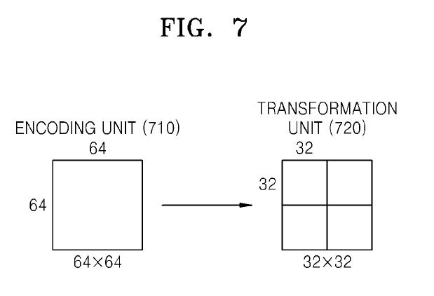

FIG. 7 illustrates a coding unit and a transformation unit, according to an exemplary embodiment.

The apparatus 100 and the apparatus 200, according to an exemplary embodiment, perform encoding with a maximum coding unit itself or with sub coding units, which are equal to or smaller than the maximum coding unit, divided from the maximum coding unit.

In the encoding process, the size of a transformation unit for frequency transformation is selected to be no larger than that of a corresponding coding unit. For example, when a current coding unit 710 has the size of 64×64, frequency transformation can be performed using a transformation unit 720 having the size of 32×32.

FIGS. 8A and 8B illustrate division shapes of a coding unit, a prediction unit, and a transformation unit, according to an exemplary embodiment.

FIG. 8A illustrates a coding unit and a prediction unit, according to an exemplary embodiment.

A left side of FIG. 8A shows a division shape selected by the apparatus 100, according to an exemplary embodiment, in order to encode a maximum coding unit 810. The apparatus 100 divides the maximum coding unit 810 into various shapes, performs encoding, and selects an optimal division shape by comparing encoding results of various division shapes with each other based on R-D cost. When it is optimal to encode the maximum coding unit 810 as it is, the maximum coding unit 810 may be encoded without dividing the maximum coding unit 810 as illustrated in FIGS. 8A and 8B.

Referring to the left side of FIG. 8A, the maximum coding unit 810 whose depth is 0 is encoded by dividing it into sub coding units whose depths are equal to or greater than 1. That is, the maximum coding unit 810 is divided into 4 sub coding units whose depths are 1, and all or some of the sub coding units whose depths are 1 are divided into sub coding units whose depths are 2.

A sub coding unit located in an upper-right side and a sub coding unit located in a lower-left side among the sub coding units whose depths are 1 are divided into sub coding units whose depths are equal to or greater than 2. Some of the sub coding units whose depths are equal to or greater than 2 may be divided into sub coding units whose depths are equal to or greater than 3.

The right side of FIG. 8A shows a division shape of a prediction unit for the maximum coding unit 810.

Referring to the right side of FIG. 8A, a prediction unit 860 for the maximum coding unit 810 can be divided differently from the maximum coding unit 810. In other words, a prediction unit for each of sub coding units can be smaller than a corresponding sub coding unit.

For example, a prediction unit for a sub coding unit 854 located in a lower-right side among the sub coding units whose depths are 1 can be smaller than the sub coding unit 854. In addition, prediction units for some (814, 816, 850, and 852) of sub coding units 814, 816, 818, 828, 850, and 852 whose depths are 2 can be smaller than the sub coding units 814, 816, 850, and 852, respectively. In addition, prediction units for sub coding units 822, 832, and 848 whose depths are 3 can be smaller than the sub coding units 822, 832, and 848, respectively. The prediction units may have a shape whereby respective sub coding units are equally divided by two in a direction of height or width or have a shape whereby respective sub coding units are equally divided by four in directions of height and width.

FIG. 8B illustrates a prediction unit and a transformation unit, according to an exemplary embodiment.

A left side of FIG. 8B shows a division shape of a prediction unit for the maximum coding unit 810 shown in the right side of FIG. 8A, and a right side of FIG. 8B shows a division shape of a transformation unit of the maximum coding unit 810.

Referring to the right side of FIG. 8B, a division shape of a transformation unit 870 can be set differently from the prediction unit 860.

For example, even though a prediction unit for the coding unit 854 whose depth is 1 is selected with a shape whereby the height of the coding unit 854 is equally divided by two, a transformation unit can be selected with the same size as the coding unit 854. Likewise, even though prediction units for coding units 814 and 850 whose depths are 2 are selected with a shape whereby the height of each of the coding units 814 and 850 is equally divided by two, a transformation unit can be selected with the same size as the original size of each of the coding units 814 and 850.

A transformation unit may be selected with a smaller size than a prediction unit. For example, when a prediction unit for the coding unit 852 whose depth is 2 is selected with a shape whereby the width of the coding unit 852 is equally divided by two, a transformation unit can be selected with a shape whereby the coding unit 852 is equally divided by four in directions of height and width, which has a smaller size than the shape of the prediction unit.

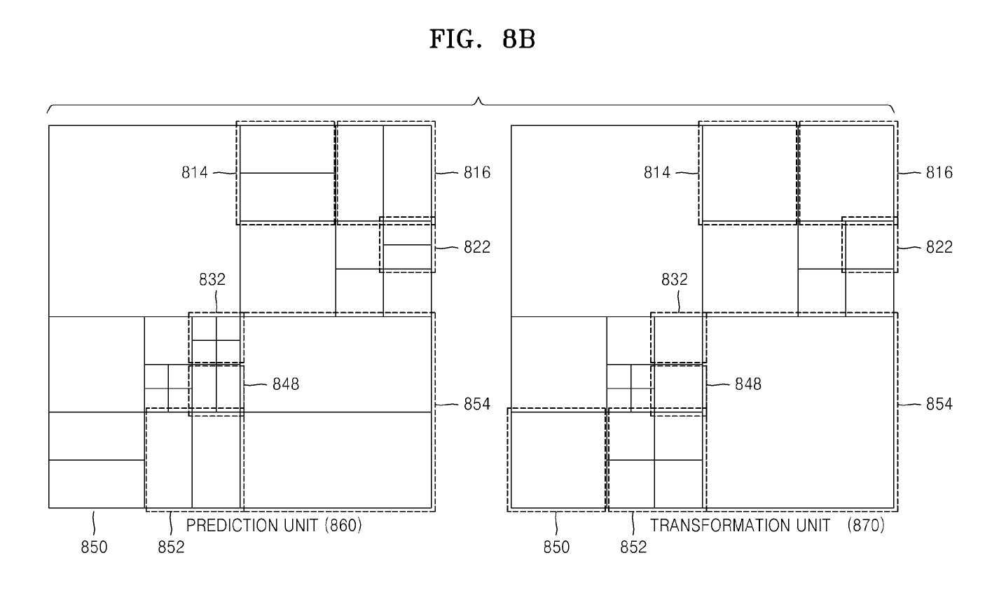

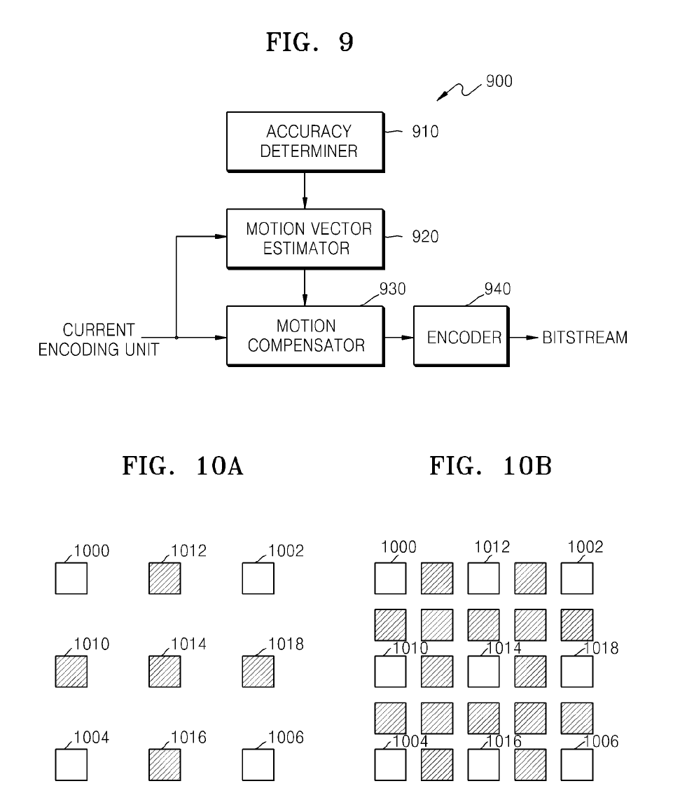

FIG. 9 is a block diagram of an apparatus for encoding an image 900 according to another exemplary embodiment.

Referring to FIG. 9, the apparatus for encoding an image 900 according to the current exemplary embodiment may be the apparatus for encoding an image 100 illustrated in FIG. 1 or an apparatus for encoding an image that will be included in the image encoder 400 illustrated in FIG. 4 and encodes the image by performing a method of encoding an image that will be described later. Referring to FIG. 9, the apparatus for encoding an image 900 according to the current exemplary embodiment includes an accuracy determiner 910, a motion vector estimator 920, a motion compensator 930, and an encoder 940.

The accuracy determiner 910 determines accuracy of a motion vector used to predict a current coding unit. For example, the accuracy determiner 910 determines one among various accuracies, i.e., accuracies of an integer pixel unit, a ½ pixel unit, a ¼ pixel unit, a ⅛ pixel unit, and the like, as accuracy of the motion vector used to predict the current coding unit.

A conventional image codec encodes an image according to fixed accuracy of a motion vector. For example, a H.264 image codec estimates a motion vector with fixed accuracy in a ¼ pixel unit, performs motion compensation and prediction-encodes the image. In the conventional image codec, the accuracy of the motion vector is fixed. Thus, the following problems exist. Firstly, if the accuracy of the motion vector is fixed to be low, the motion vector cannot be accurately estimated, and thus motion compensation cannot be accurately performed such that the efficiency of prediction-encoding is lowered. Reversely, if the accuracy of the motion vector is fixed to be high, many bits are required to encode the motion vector so that the compression ratio upon encoding is lowered.

Thus, the accuracy determiner 910 adaptively encodes an image in consideration of characteristics of the image by variably determining the accuracy of the motion vector. In other words, by determining different accuracies of the motion vector on an image to be encoded using higher accuracy of the motion vector and on an image that may be efficiently encoded with lower accuracy of the motion vector, the image may be adaptively encoded in consideration of the characteristics of the image.

The accuracy determiner 910 may determine the accuracy of the motion vector based on the depths described above with reference to FIGS. 3, 6, 8A, and 8B. Thus, a criterion for determining various accuracies will now be described.

According to an exemplary embodiment, the accuracy determiner 910 may determine the accuracy of the motion vector of the current coding unit based on a maximum depth. In this case, since the maximum depth is determined for each slice unit, each picture unit or each maximum coding unit, the accuracy of the motion vector is also determined for each slice unit, each picture unit or each maximum coding unit.

The accuracy determiner 910 may estimate the motion vector by decreasing the accuracy of the motion vector as the maximum depth increases. The maximum depth indicates a degree stepwise decreasing from the size of a maximum coding unit to the size of a minimum coding unit. As the maximum depth increases, the maximum coding unit may include a minimum coding unit of a small size. If the minimum coding unit is small, the maximum coding unit may be split into smaller partitions. Thus, the number of motion vectors for each maximum coding unit may be increased. Thus, when the motion vector is estimated by further decreasing the accuracy of the motion vector as the maximum depth increases, the compression ratio upon encoding may be increased in spite of an increase in the number of motion vectors.

Alternatively, the accuracy determiner 910 may estimate the motion vector by increasing the accuracy of the motion vector as the maximum depth increases. As described above, as the maximum depth increases, the size of the minimum coding unit is decreased. Also, a probability that the minimum coding unit may be set to be small in a complex image region is high. Thus, motion compensation should be more accurately performed so as to increase the compression ratio upon encoding. For more accurate motion compensation, the accuracy of the motion vector should be further increased.

According to another exemplary embodiment, the accuracy determiner 910 may determine the accuracy of the motion vector based on the depth of the current coding unit. The accuracy of the motion vector may be determined for each coding unit having different depths. As described above, the depth of the current coding unit indicates a degree stepwise decreasing from the size of the maximum coding unit to the size of the current coding unit.

The accuracy determiner 910 may determine the motion vector by increasing accuracy of the motion vector as the depth of the current coding unit increases. As described above, the probability that the size of a coding unit may be small in the complex image region is high, and in the complex image region, motion compensation should be more accurately performed so that the compression ratio upon encoding may be increased. However, as the depth of the current coding unit increases, the smaller the size of the current coding unit is. Thus, for more accurate motion compensation, the motion vector may be estimated by increasing the accuracy of the motion vector.

Reversely, the accuracy determiner 910 may estimate the motion vector by decreasing the accuracy of the motion vector as the depth of the current coding unit decreases. As the size of the current coding unit is increased, the compression ratio may not be affected by inaccurate motion compensation. A probability that the size of a coding unit may be large in a planar region is high, and in the planar region, accurate motion compensation may be performed without the need of increasing the accuracy of the motion vector. Thus, as the depth of the current coding unit decreases, i.e., as the size of the current coding unit is increased, the motion vector is estimated by decreasing the accuracy of the motion vector.

When the accuracy of the motion vector is determined by the accuracy determiner 910, the motion vector estimator 920 estimates the motion vector of the current coding unit according to the determined accuracy. The motion vector estimator 920 interpolates the reference picture according to the determined accuracy and estimates the motion vector of the current coding unit by using the interpolated reference picture. The motion vector estimator 920 may estimate the motion vector by interpolating only a predetermined region of the reference picture to be searched.

FIGS. 10A and 10B illustrate interpolated reference pictures according to an exemplary embodiment.

Referring to FIG. 10A, when the accuracy determiner 910 determines the accuracy of the motion vector of the current coding unit as a ½ pixel unit, the motion vector estimator 920 generates ½ pixels 1010 through 1016 among integer pixels 1000, 1002, 1004, and 1006 by interpolating the reference picture.

Referring to FIG. 10B, when the accuracy determiner 910 determines the accuracy of the motion vector of the current coding unit as a ¼ pixel unit, the motion vector estimator 920 generates ¼ pixels between integer pixels 1000 through 1016 and ½ pixels 1010 through 1016 or between the ½ pixels 1010 through 1016.

Referring back to FIG. 9, the motion vector estimator 920 may be estimated based on a prediction unit. As illustrated in FIGS. 3, 6, 8A, and 8B, the coding unit (a maximum coding unit and a sub coding unit) may be different from the prediction unit. Thus, when a plurality of prediction units are included in the current coding unit, the motion vector estimator 920 estimates the motion vector for each of the plurality of prediction units.

The motion compensator 930 performs motion compensation on the current coding unit by using the motion vector estimated by the motion vector estimator 920. The motion compensator 930 searches a block corresponding to the current coding unit according to the motion vector and predicts the current coding unit based on the result of searching. When a plurality of prediction units are included in the current coding unit, the motion compensator 930 predicts the current coding unit by performing motion compensation on each of the plurality of prediction units.

The encoder 940 encodes the current coding unit based on the result of motion compensation of the motion compensator 930. The encoder 940 generates a residual block of the current coding unit based on the result of predicting the current coding unit and generates data about the current coding unit by performing transformation, quantization, and entropy encoding on the generated residual block. Also, the encoder 940 generates data about the motion vector by performing entropy encoding on the motion vector with predetermined accuracy generated by the motion vector estimator 920.

According to another exemplary embodiment, the apparatus for encoding an image 900 may repeatedly perform encoding for all motion vector accuracies so as to determine optimum accuracy of the motion vector. For example, the apparatus for encoding an image 900 performs motion vector estimation, motion compensation, and encoding according to the accuracy of the integer pixel unit and repeatedly performs motion vector estimation, motion compensation, and encoding according to the accuracy of the ½ pixel unit. Then, the apparatus for encoding an image 900 determines the optimum accuracy of the motion vector by comparing the result of encoding for each accuracy. The apparatus for encoding an image 900 may repeatedly perform motion vector estimation, motion compensation, and encoding described above for more various accuracies, i.e., accuracies of the integer pixel unit, the ½ pixel unit, the ¼ pixel unit, and the ⅛ pixel unit, and may also determine the optimum accuracy of the motion vector by comparing the result of encoding.

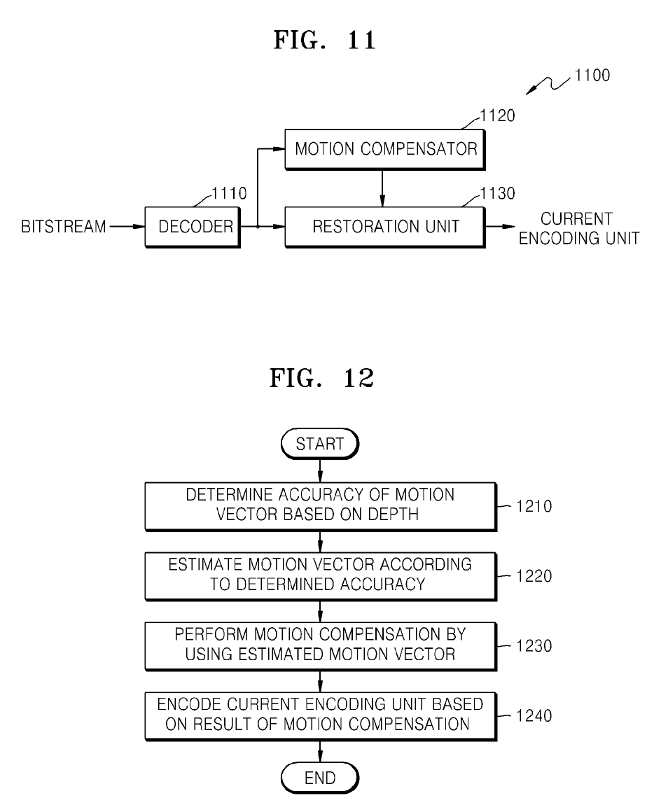

FIG. 11 is a block diagram of an apparatus for decoding an image 1100 according to another exemplary embodiment.

Referring to FIG. 11, the apparatus for decoding an image 1100 according to the current exemplary embodiment may be the apparatus for encoding an image 200 illustrated in FIG. 2 or an apparatus for encoding an image that will be included in the image decoder 500 illustrated in FIG. 5 and decodes the image by performing a method of decoding an image that will be described later. Referring to FIG. 11, the apparatus for encoding an image 1100 according to the current exemplary embodiment includes a decoder 1110, a motion compensator 1120, and a restoration unit 1130.

The decoder 1110 decodes data about the current coding unit and data about the motion vector by receiving a bitstream. The data about the current coding unit is data about the residual block of the current coding unit. The decoder 1110 restores the residual block of the current coding unit by performing entropy encoding, inverse quantization, inverse transformation on the data about the residual block. The motion vector of the current coding unit is a motion vector estimated according to controlled accuracy. The decoder 1110 restores the motion vector by performing entropy decoding on the data about the motion vector. The accuracy of the motion vector may be determined according to a maximum depth or a depth of the current coding unit. When the accuracy of the motion vector is determined according to the maximum depth, the accuracy of the motion vector may be determined as a picture unit, a slice unit or a maximum coding unit, as described above.

The motion compensator 1120 performs motion compensation according to the motion vector restored by the decoder 1110 and predicts the current coding unit. The motion compensator 1120 interpolates a reference picture according to the accuracy of the restored motion vector and predicts the current coding unit by searching the interpolated reference picture according to the motion vector.

The restoration unit 1130 restores the current coding unit based on the result of decoding the data about the current coding unit performed by the decoder 1110 and the result of motion compensation performed by the motion compensator 1120. The restoration unit 1130 restores the current coding unit by adding the residual block of the current coding unit restored by the decoder 1110 and the result of motion compensation generated by the motion compensator 1120.

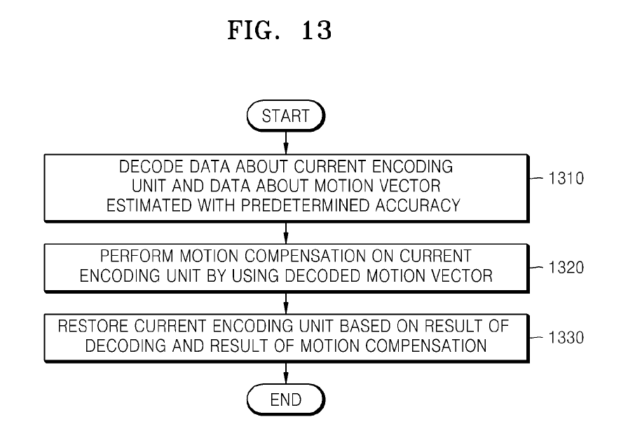

FIG. 12 is a flowchart illustrating a method of encoding an image according to an exemplary embodiment.

In Operation 1210, an apparatus for encoding an image according to an exemplary embodiment determines the accuracy of a motion vector used to predict a current coding unit based on a depth. The depth may be a maximum depth determined for each picture, slice or maximum coding unit, as described above. In addition, the accuracy of the motion vector is determined based on the depth of the current coding unit so that different accuracies of the motion vector may also be determined for all coding units.

In Operation 1220, the apparatus for encoding an image estimates the motion vector of the current coding unit according to the accuracy of the motion vector determined in Operation 1210. A reference picture is interpolated according to the determined accuracy, and the motion vector of the current coding unit is estimated based on the interpolated reference picture. The same block as the current coding unit or a similar block to the current coding unit is searched using a predetermined evaluation function, and the motion vector of the current coding unit is estimated according to the result of searching.

In Operation 1230, the apparatus for encoding an image performs motion compensation of the current coding unit by using the motion vector estimated in Operation 1220. The current coding unit is predicted by searching the interpolated reference picture according to the motion vector estimated in Operation 1220.

In Operation 1240, the apparatus for encoding an image encodes the current coding unit based on the result of motion compensation in Operation 1230. A residual block of the current coding unit is generated based on the result of motion compensation, and data about the current coding unit is generated by performing transformation, quantization, and entropy encoding on the residual block. In addition, data about the motion vector is generated by performing entropy encoding on the motion vector of the current coding unit.

The apparatus for encoding an image may determine the accuracy of the motion vector of the current coding unit by repeatedly performing Operations 1220 through 1240 for different accuracies of the motion vector. The optimum accuracy of the motion vector of the current coding unit may be determined by repeatedly performing Operations 1220 through 1240 for accuracies of an integer pixel unit, a ½ pixel unit, a ¼ pixel unit, a ⅛ pixel unit, and the like and by comparing the results of encoding.

FIG. 13 is a flowchart illustrating a method of decoding an image according to an exemplary embodiment.

Referring to FIG. 13, in Operation 1310, an apparatus for decoding an image according to an exemplary embodiment decodes data about a current coding unit and data about a motion vector. A residual block of the current coding unit is restored by performing entropy decoding, inverse quantization, and inverse transformation on the data about the current coding unit. In addition, the motion vector of the current coding unit is restored by performing entropy decoding on the data about the motion vector. The accuracy of the restored motion vector may be accurately determined based on a maximum depth or a depth of the current coding unit, as described above with reference to FIG. 12.

In Operation 1320, motion compensation is performed on the current coding unit by using the motion vector decoded in Operation 1310. A reference picture is interpolated according to the accuracy of the motion vector decoded in Operation 1310, and the interpolated reference picture is searched using the motion vector. The current coding unit is predicted based on the result of searching.

In Operation 1330, the apparatus for decoding an image restores the current coding unit based on the result of decoding the data about the current coding unit in Operation 1310 and the result of motion compensation in Operation 1320. The current coding unit is restored by adding the residual block of the current coding unit restored in Operation 1310 and the result of motion compensation in Operation 1320.

While the exemplary embodiment has been particularly shown and described with reference to exemplary embodiments thereof, it will be understood by those of ordinary skill in the art that various changes in form and details may be made therein without departing from the spirit and scope of the exemplary embodiment as defined by the following claims. In addition, a system according to the exemplary embodiment can be implemented using a computer readable code in a computer readable recording medium.

For example, an apparatus for encoding an image, an apparatus for decoding an image, an image encoder, an image decoder according to exemplary embodiments, can include a bus coupled to units of each of the devices shown in FIGS. 1, 2, 4, 5, 9, and 11 and at least one processor connected to the bus. In addition, a memory coupled to at least one processor for performing commands as described above can be included and connected to the bus to store the commands and received messages or generated messages.

The computer readable recording medium is any data storage device that can store data which can be thereafter read by a computer system. Examples of the computer readable recording medium include read-only memory (ROM), random-access memory (RAM), CD-ROMs, magnetic tapes, floppy disks and, optical data storage devices. The computer readable recording medium can also be distributed over network coupled computer systems so that the computer readable code is stored and executed in a distributed fashion.

What is claimed is:

1. A method of encoding an image, the method comprising:
determining an accuracy of a motion vector used to predict a current coding unit based on a depth that indicates a stepwise size decrease from a size of a maximum coding unit to a size of a predetermined coding unit;
estimating a motion vector of the current coding unit according to the determined accuracy of the motion vector;
performing motion compensation on the current coding unit by using the estimated motion vector; and
encoding the current coding unit based on a result of performing motion compensation.

2. The method of claim 1, wherein the determining of the accuracy of the motion vector comprises determining the accuracy of the motion vector based on a maximum depth that indicates a stepwise size decrease from the size of the maximum coding unit to a size of a minimum coding unit.

3. The method of claim 2, wherein the maximum depth is set for each slice or picture.

4. The method of claim 1, wherein the determining of the accuracy of the motion vector comprises determining the accuracy of the motion vector based on a depth that indicates a stepwise decrease in size from the size of the maximum coding unit to a size of the current coding unit.

5. The method of claim 1, wherein the estimating of the motion vector comprises:
interpolating a reference picture based on the determined accuracy of the motion vector; and
estimating the motion vector of the current coding unit by using the interpolated reference picture.

6. An apparatus for encoding an image, the apparatus comprising:
an accuracy determiner which determines an accuracy of a motion vector used to predict a current coding unit based on a depth that indicates a stepwise size decrease from a size of a maximum coding unit to a size of a predetermined coding unit;
a motion vector estimator which estimates a motion vector of the current coding unit according to the determined accuracy of the motion vector;
a motion compensator which performs motion compensation on the current coding unit by using the estimated motion vector; and
an encoder which encodes the current coding unit based on a result of the motion compensation.

7. The apparatus of claim 6, wherein the accuracy determiner determines the accuracy of the motion vector based on a maximum depth that indicates a stepwise size decrease from the size of the maximum coding unit to a size of a minimum coding unit.

8. The apparatus of claim 7, wherein the maximum depth is set for each slice or picture.

9. The apparatus of claim 6, wherein the accuracy determiner determines the accuracy of the motion vector based on a depth that indicates a stepwise size decrease from the size of the maximum coding unit to a size of the current coding unit.

10. The apparatus of claim 6, wherein the motion estimator interpolates a reference picture based on the determined accuracy of the motion vector and estimates the motion vector of the current coding unit by using the interpolated reference picture.

11. A method of decoding an image, the method comprising:
decoding data about a current coding unit and data about a motion vector estimated with a predetermined accuracy;
performing motion compensation on the current coding unit by using the decoded data about the motion vector; and
restoring the current coding unit based on a result of decoding the data about the current coding unit and a result of performing motion compensation,
wherein the predetermined accuracy is an accuracy of the motion vector determined based on a depth that indicates a stepwise size decrease from a size of a maximum coding unit to a size of a predetermined coding unit.

12. The method of claim 11, wherein the accuracy of the motion vector is an accuracy of the motion vector determined based on a maximum depth that indicates a stepwise size decrease from the size of the maximum coding unit to a size of a minimum coding unit.

13. The method of claim 12, wherein the maximum depth is set for each slice or picture.

14. The method of claim 11, wherein the accuracy of the motion vector is an accuracy of the motion vector determined based on a depth that indicates a stepwise size decrease from the size of the maximum coding unit to a size of the current coding unit.

15. An apparatus for decoding an image, the apparatus comprising:
a decoder which decodes data about a current coding unit and data about a motion vector estimated with a predetermined accuracy;
a motion compensator which performs motion compensation on the current coding unit by using the decoded data about the motion vector; and
a restoration unit which restores the current coding unit based on a result of decoding the data about the current coding unit and a result of motion compensation,
wherein the predetermined accuracy is an accuracy of the motion vector determined based on a depth that indicates a stepwise size decrease from a size of a maximum coding unit to a size of a predetermined coding unit.

16. The apparatus claim 15, wherein the accuracy of the motion vector is an accuracy of the motion vector determined based on a maximum depth that indicates a stepwise size decrease from the size of the maximum coding unit to a size of a minimum coding unit.

17. The apparatus of claim 16, wherein the maximum depth is set for each slice or picture.

18. The apparatus of claim 15, wherein the accuracy of the motion vector is an accuracy of the motion vector determined based on a depth that indicates a stepwise size decrease from the size of the maximum coding unit to a size of the current coding unit.

19. A computer readable recording medium having recorded thereon a program for executing the method of claim 1.

20. A computer readable recording medium having recorded thereon a program for executing the method of claim 11.
